(19) United States
(12) Patent Application Publication
(10) Pub. No.: US 2002/0077144 A1
(43) Pub. Date: Jun. 20, 2002

(54) Mobile terminal with zone-dependent operational parameter settings

(76) Inventors: Ralf Keller, Wuerselen (DE); Thorsten Lohmar, Aachen (DE)

Correspondence Address: Spencer C. Patterson, Esq., Jenkens and Gilchrist, P.C., 3200 Fountain Place, 1445 Ross Ave., Dallas, TX, 75202, US

(21) Appl. No.: 09/924,928

(22) Filed: Aug. 8, 2001

(30) Foreign Application Priority Data
Aug. 9, 2000 (EP) 00117076.0

(51) Int. Cl. H04M 1/00

(52) U.S. Cl. 455/550; 455/11.1; 455/435

(57) ABSTRACT

The present invention relates to a method for setting operational parameters in a mobile terminal. There are operational parameter settings for the terminal, which depend on the location zone thereof. A zone information is allocated to the location zone, which is wirelessly sent in a limited transmission area. The terminal receives the zone information, determines operational parameters therefrom and sets them as present operational parameters. The invention, moreover, relates to a mobile terminal, for which operational parameter settings exist, which depend on a wirelessly sent zone information, as well as a zone information transmitter for signaling a zone information for setting operational parameters of a mobile terminal. The invention, moreover, relates to a computer program for executing the method.

### FIELD OF THE INVENTION

The present invention relates to a mobile terminal, especially a communication device of a mobile radio network. The invention especially relates to a mobile terminal having operational parameter settings, which depend on the location zone of the terminal, and a method for setting operational parameters of a mobile terminal.

### BACKGROUND OF THE INVENTION

Disclosed in the publication WO 98/27778 are a method and a device for displaying a text on the sight screen of a mobile terminal, which forms part of a mobile radio system offering location-dependent services. In the described method location-dependent services are services, which are provided to the mobile terminal by the communication system in the area influenced by a certain switching center. If the mobile terminal registers in the switching center, the switching center requests user data from a subscriber data base of said system. On the basis of said user data the switching center sends a service zone identification value to the mobile terminal. The mobile terminal compares the received service zone identification value with stored service zone identification values. A text (e.g. “inner city”, “office” or “home zone”) is allocated to each of the stored service zone identification values in the mobile terminal. If the service zone identification value received corresponds with one of the stored values, the allocated text is displayed on the sight screen of the mobile terminal for informing a user on the service zone in which the mobile terminal is presently located.

The described method for displaying the text requires the determination of the service zone identification value by means of the mobile radio system. It is bound to the availability of the network, i.e. in the case of a breakdown of the mobile radio system the display text cannot be signaled to the mobile terminal. With the method described it is impossible to set operational parameters of the terminal.

The User's Guide of the Ericsson Mobile Phone T28s (page 88 if, first edition June 1999, Ericsson Mobile Communications AB, publication number EN/LZT 126 1456 R 1 A) discloses a mobile phone comprising a number of pre-defined profiles. Such a profile consists of a group of settings for specific environments or situations. If a mobile radio subscriber, for example, participates in a meeting, he can activate the profile “meeting” with the settings suited for this situation, e.g. reduced call loudness, activated vibration alarm, acceptance of all calls. If different accessory devices are connected to the mobile phone, profiles will be activated automatically. If the phone is, for example, inserted into a car adapter, the profile “car” will be activated, i.e. among others, maximum call loudness, deactivated vibration alarm, switched-on illumination.

For activating a group of settings in a mobile phone, the above-mentioned device requires a subscriber action, for instance, the selection of a corresponding menu item, the operation of a functional key or the connection of an accessory part to the hardware interface of the mobile phone, for example, by the connection of the phone to a loading station, a handsfree equipment or a car adapter.

### OBJECT OF THE INVENTION

It is the object of the present invention to provide a method and a device allowing the automatic setting of operational parameters of a mobile terminal, and allowing an improved operation of the terminal.

According to the invention this object is provided by the teaching of independent claims 1, 16, 26, 32 and 33.

A mobile terminal as defined by the present invention is, for example, a mobile phone working in a mobile radio network, a phone installed in a vehicle, a personal digital assistant PDA, a laptop or a device, which can be connected to an additional terminal for the communication with a mobile radio network, such as a PCMCIA card for a laptop.

Such a terminal, i.e. a communication device of a mobile radio system, usually comprises a plurality of operational parameters, the settings of which can be adjusted in response to the location zone. Due to the plurality of different operational parameters it is particularly advantageous for the user of such a communication device, if the adjustment takes place automatically.

Apart from, for example, a GSM, GPRS or UMTS transceiver, the terminal may comprise additional transmission devices, such as a Bluetooth™, DECT or WLAN adapter.

The operating mode of the terminal depends on set operational parameters. Thus, for example, a certain call loudness can be set in a mobile phone, a vibration alarm can be activated or a call routing profile inputted by the user may be set. In response to the present operational parameter setting, a laptop or a PDA can offer different application programs to the user. The energy supply of a terminal can be effected by an integrated energy source or, in case of another operational parameter setting, by a connected loading station. In response to the operational parameter setting certain terminal functions can, moreover, be transferred to other devices. For example, a microphone or a signal processor for the compensation of echoes in a mobile phone can be deactivated, if an additional handsfree device is used. Furthermore, a terminal can be switched off by a certain operational parameter setting.

According to the present invention there are operational parameter settings for the terminal, which are dependent on the location zone. A location zone is, for example, a conference room, the interior of a car, a theatre, a restaurant or a church. To a location zone a zone information is respectively allocated, which designates the location zone. Said zone information is wirelessly transmitted in a limited transmission area. Transmission area and location zone may be identical. A zone information transmitter may, for example, send out the zone information “conference room” inside a conference room, which results in a certain operational parameter setting in the terminal, such as in muting of the call tone.

Alternatively, the location zone and the transmission area do not completely or not at all correspond with each other. In particular, the zone information for a location zone, which can only be reached via defined accesses, can merely be sent out in the accesses. A zone information transmitter can, for example, transmit the zone information “airplane” inside a gangway as limited transmission area, which results in the deactivation of the terminal, while the location zone is represented by the plane being accessed by the gangway. The operational parameter setting is maintained also after the transmission area has been left, until a new setting takes place.

The terminal receives the zone information wirelessly sent in the transmission area. The reception takes place by means of a first transmission device in the terminal, for instance, by monitoring a broadcast channel. The monitoring can, for example, take place continuously or in certain time intervals. In the simplest case, the reception of the zone information takes place in one step, i.e. if only the zone information as such is transmitted by the zone information transmitter. Alternatively, the reception of the zone information may take place in several steps by comprising an authentication dialogue or a decryption. Upon the reception the terminal determines operational parameters by means of the received zone information and sets them.

A computer unit in the terminal has the task of determining and setting the operational parameters. The setting is preferably effected by means of a status memory, which indicates the presently valid parameters for the terminal.

The invention allows in an easy manner a location-dependent operational parameter setting in a mobile terminal. A user interaction is not required. Without requiring any activity by the user he thereby advantageously has a terminal, the operational parameter settings of which are automatically adjusted to his environment. The automatic adjustment of the operational parameter setting is also advantageous for the environment of the user. Thus, for instance, visitors of a theatre performance will not be disturbed by ringing mobile phones, if, by means of the received zone information “theatre” the call tone of a mobile phone is switched to mute and the vibration alarm is activated. The invention may advantageously also fulfill safety requirements of certain location zones. Thus, for example, the zone information “airplane” may result in the legally prescribed deactivation of a mobile phone in the plane.

The mobile terminal receives the zone information by means of a first transmission means. A second transmission means is provided for the communication of the communication device with the mobile radio system. By setting the operational parameters the communication with the mobile radio system takes place by means of the first transmission means.

According to claim 16 the mobile terminal comprises a second transmission means for the communication with the mobile radio network. The communication with the mobile radio system is adapted to be provided by means of the first transmission means.

The provision of two different transmission means is particularly advantageous, as an operational parameter setting for the communication device can be effected independently of the mobile radio system and the network coverage or cell partitioning thereof. Resources in the mobile radio network are not necessary. The definition of the location zones does not depend on the cell structure of the mobile radio network, and can be changed flexibly and independently of the mobile radio network. Especially advantageous for this purpose is the use of a transmission means according to the Bluetooth™, DECT or WLAN standard. The transmission may also be realized by means of an infrared or ultrasound transmission device, or by inductive transmission, e.g. by a TAG system.

An operational parameter setting effecting the communication of the terminal with the mobile radio system by means of the first transmission means is, for instance, advantageous in closed vehicles, in which the connection to the mobile radio network by means of the second transmission means is rendered difficult due to screening effects caused, for instance, by metal-vaporized screens in the vehicle. When the user of a mobile phone gets into his car, a mobile phone receives the zone information “car” by means of its first transmission means and sets the operational parameters such that the second transmission means being provided for the communication with the base stations of the mobile radio network is deactivated and that the communication of the mobile phone with the mobile radio system is realized by means of the first transmission means and a corresponding base station being installed in the interior of the car. The base station in the car sets up the connection to the mobile radio system by means of an antenna, which, for example, is installed outside the car. Thus, the user may also use his mobile phone in vehicles, in which the mobile radio reception usually is difficult or even impossible.

In order to reach the base station installed in the interior of the car, the mobile phone requires a smaller transmission power than would be required to reach a base station of the mobile radio system installed outside of the car. By switching to the first transmission means, energy from the battery is saved. This provides for a larger available stand-by time or, respectively, conversation time of the mobile phone.

Another advantageous realization focuses on the use of a distance parameter value indicating whether the mobile terminal is located within the location zone. It relates to a method for setting operational parameters of a mobile terminal having operational parameter settings, which depend on a location zone of the terminal, wherein a zone information being wirelessly transmitted in a limited transmission area is allocated to the location zone, and comprises the steps of receiving the zone information by the terminal, determining a distance parameter, and performing, if the distance parameter indicates that the mobile terminal is located within the location zone, the steps of determining operational parameters in the terminal by means of the received zone information, and setting the determined operational parameters as operational parameters of the terminal.

The use of a distance parameter is useful, as it allows the mobile terminal not only to determine the existence of a location zone, in which a dedicated parameter setting is useful or a certain application is appropriate, but it allows in addition to determine the distance to the location zone. Thereby, the setting of the operational parameters suited for the location zone can be allowed only, if the mobile terminal is within the location zone, e.g. in a certain distance to the sender of the zone information. E.g., a car profile for a location zone is activated only, if the mobile terminal is located in the car or close to the car.

Advantageously a zone information transmitter can be used, which provides a higher output power for the transmission of the zone information, and thus minimizing the risk of transmission errors, which can make the use of complex, error robust transmission protocols unnecessary.

Another advantageous realization relates to a zone information transmitter for signaling a zone information for setting operational parameters in a mobile terminal. It comprises a first transmission means, which receives a zone information request and sends out an allocated zone information wirelessly in a limited transmission area. It moreover comprises a zone information memory, which stores zone information data, and a computer unit, which determines the zone information allocated to the zone information request by means of the stored zone information data.

Such a zone information transmitter can be produced cost-efficiently. The necessary components merely require a small need of space and can be accommodated in a discrete casing, so that the zone information transmitter located in the transmission area is inconspicuous. The transmitter need not be connected to a mobile radio system or a computer network. For operation no additional infrastructure is required, and it can, therefore, be applied in a flexible manner.

The invention can advantageously be realized in the form of a computer program. This allows the use of the invention in terminals without requiring changes in the hardware. Moreover, the computer program allows the easy to implement and cost-efficient performance of tests and simulations in the terms of manufacture and development.

Additional advantageous embodiments and improvements of the invention can be inferred from claims 2 to 15, 17 to 25, 27 to 31 and 34.

In the embodiment according to claim 2 the terminal sends out a zone information request. According to claim 18 this preferably takes place by means of the first transmission means of the terminal. By requesting the zone information, a regular monitoring of a broadcast channel can be waived for the reception of said zone information, whereby energy is saved and, for example, the duration of the battery is prolonged. Additionally advantageous is the sending of zone information upon request instead of by means of broadcast transmissions, if there are different individual zone information for individual users or user groups for a location zone. The terminals then do not have to evaluate a plurality of irrelevant zone information, but only the exactly requested zone information. The zone information request can, for example, be sent out by the terminal on a regular basis.

In the embodiment according to claim 3 zone information and operational parameters are allocated to each other and stored in the terminal. The determination of the operational parameters is done by comparing the received zone information with stored zone information so as to determine a correspondence. The operational parameters allocated the corresponding zone information are determined as the operational parameters.

According to claim 19 the zone information and the operational parameters are allocated to each other and stored in a zone information memory of the terminal. The comparison is realized by a computer unit in the terminal.

The use of comparative tables being stored in the terminal allows an easy and flexible allocation of operational parameter settings and zone information by the manufacturer of the terminal, or the user. The allocations may be changed and extended. The operational parameter settings can easily be adjusted to terminals of different manufacturers.

In the embodiment according to claim 4 an interpretation provision is stored in the terminal. The determination of the operational parameters is realized by the interpretation of the received zone information by means of the interpretation provision. According to claim 20 this is realized by the computer unit. The interpretation provision is usually stored in an interpretation provision memory in the terminal, for instance, in a memory or memory section of the computer unit. Alternatively, the interpretation provision may be loaded by the computer unit from an additional memory or memory section of the terminal.

The computer unit of the terminal interprets the received zone information by means of the stored provision. Advantageously, memory space is thereby saved in the terminal, if a comparatively short interpretation provision is stored instead of extensive allocation tables. The use of an interpretation provision for determining the operational parameter setting is also advantageous in a combination with allocation tables, as, for instance, multiple or hierarchically structured zone information are thereby supported, which allows a detailed as well as an individual zone information.

In the embodiment according to claim 5 the setting of the determined operational parameters is effected by storing the status information in a status information memory of the terminal. Thus, memory space can be saved in the terminal, if, for example, a flag is determined and set as status information, which designates the presently valid setting in the table of operational parameter settings. The status information memory can be realized as a separate memory module or as memory section of a memory module.

According to claim 6 and claim 21 is the first transmission means a short range transceiver. E.g., a Bluetooth transceiver can be advantageously be used.

According to claim 7 and claim 17 is the second transmission means deactivated by setting the operational parameters. This can minimize the power consumption of the mobile terminal, and it can reduce the risk of interference that might be caused by the simultaneous use of two transmission means. Depending on the use case, the deactivation can be done automatically or after a user interrogation. In the latter case, the user can choose the transmitter or transmitters that should be used.

In the embodiment according to claim 8 the zone information received comprises several types of zones. There is, for example, a general zone type (e.g. ‘car’), a user-dependent group zone type (e.g. ‘official car’), a user-independent group zone type (e.g. ‘rented car’), an individual user-dependent zone type (e.g. ‘Ulrike_Mustermann’), or an individual user-independent zone type (e.g. ‘vehicle_with_license_number AC-XYZ’). This allows the configuration of operational parameter settings and zone information to be highly flexible. Thus, individual properties for certain users or user groups, which are shown in individual operational parameter settings of mobile terminals, can be allocated to the location zones of mobile terminals. Terminals of different users can have different, automatically adjusted operational parameters in the same location zone.

According to claim 10 determines the mobile terminal a distance parameter value. The steps of determining operational parameters in the terminal and setting the determined operational parameters are performed, if the distance parameter value indicates that the mobile terminal is located within the location zone. Therefore, the mobile terminal does not consider weak zone information signals, which were received without purpose. Unintentional changes of operation parameter settings can be avoided.

The same advantages apply for claim 22, wherein the mobile terminal is adapted to determine a distance parameter value indicative for a distance of the mobile terminal to the location zone.

According to claim 11 is the distance parameter value determined by means of a location information. Said location information can be gained in an easy way, reliable and with a high precision, e.g., from a GPS device.

According to claim 12 is the distance parameter value determined by means of a signal received from a sender signaling the zone information. Advantageously there is no need for a separate device to determine the location information, as this information can be derived form the zone information signal as such, e.g. by means of a field strength measurement.

According to claim 13 and claim 23 is the indication, whether the mobile terminal is located within the location zone determined by comparing the distance parameter value with a reference value. Advantageously can the reference value representing a threshold be optimized with regard to the individual mobile terminal, e.g. its transceiver sensitivity.

According to claim 14 and claim 24 is the reference value negotiated between the mobile terminal and a sender signaling the zone information. Therefore, individual characteristics of the sender, e.g. with regards of its output power, and of the location zone defined can be taken into consideration.

Claim 30 refers to a corresponding sender. A zone information sender is adapted to negotiate a reference value with the mobile terminal, wherein said reference value is provided for a comparison with a distance parameter value to indicate whether the mobile terminal is located within the location zone.

According to claim 15 and claim 25 is the switchover to the first transmission means performed on a user request. This allows the user the total control of the operation parameter settings of the mobile terminal.

Another embodiment according to claim 27 relates to a zone information transmitter, which is mobile. This allows the definition of a mobile transmission area or a mobile location zone, for which a specific operational parameter setting of a mobile terminal is to be valid. Especially advantageous is the use of a mobile zone information transmitter in a vehicle.

Another embodiment according to claim 28 relates to a zone information transmitter, wherein zone information requests and zone information are allocated to each other and stored in the zone information memory, and wherein the computer unit detects by means of comparison a correspondence between the received and a stored zone information request and determines the zone information allocated to the corresponding zone information request as zone information to be sent.

The use of comparative tables stored in the zone information transmitter allows an easy and flexible allocation of zone information requests and zone information by the manufacturer of the zone information transmitter or the operator. The allocations may be easily changed and extended.

In another embodiment according to claim 29 the computer unit of the zone information transmitter determines the zone information by means of an interpretation provision. Said interpretation provision is usually stored in an interpretation provision memory of the zone information transmitter, e.g. in a memory or memory section of the computer unit. Alternatively, the interpretation provision may be loaded by the computer unit from an additional memory or memory section of the zone information transmitter. Said embodiment saves memory space. It is advantageous in case of multipart zone information requests, by means of which individual zone information may be requested. Multipart zone information requests may be ambiguous for a zone information transmitter, if, for example, certain parts of the zone information request cannot be evaluated. In this case the interpretation provision can indicate the parts of the zone information request, which are evaluated for determining the zone information.

In the embodiment according to claim 31 the zone information transmitter comprises a second transmission means for the communication with a mobile radio network. This is favorable in vehicles, in which screening effects render the direct communication of a terminal with the mobile radio network difficult or impossible. The transmitted zone information informs the terminal on the possibility of an indirect communication with the mobile radio network by means of the zone information transmitter. The changeover of the terminal transmission means does not require the interaction by a user, so that the user of the mobile radio communication can be reached permanently.

According to claim 34 the computer program is stored on a computer-readable medium. This allows the easy use of the invention in different devices, such as test systems, simulation systems or machines for the manufacture of terminals.

In the following, the invention will be explained in more detail by means of embodiments and the figures.

### BRIEF DESCRIPTION OF THE FIGURES

FIG. 1 shows an application of the present invention for a location zone in a vehicle,

FIG. 2 shows another application of the invention,

FIG. 3 shows an exchange of information between a zone information transmitter and a mobile terminal,

FIG. 4 shows another exchange of information between a zone information transmitter and a mobile terminal,

FIG. 5 shows an allocation of zone information and operational parameter settings in a terminal,

FIG. 6 shows an interpretation provision for zone information in a terminal,

FIG. 7 shows different zone types and their allocation to operational parameter settings in a terminal,

FIG. 8 shows a simplified illustration of components of a mobile terminal,

FIG. 9 shows a simplified illustration of components of a zone information transmitter.

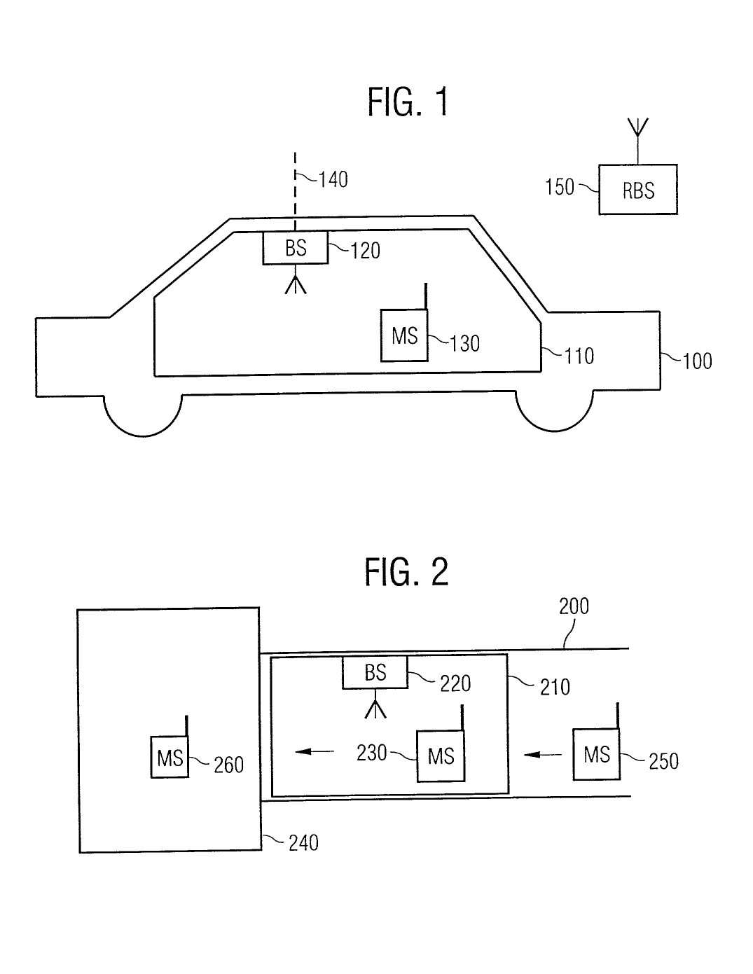

FIG. 1 shows a vehicle 100, in the passenger cell 110 of which a zone information transmitter BS 120 is installed. The zone information transmitter 120 wirelessly sends out a zone information inside the passenger cell 110 of vehicle 100, for instance, the zone information “car”. Inside the entire passenger cell 110 said zone information is valid for terminals being located in said location zone. The zone information is sent out inside the entire passenger cell 110. In the illustrated example, the location zone, to which the zone information is allocated, and the limited transmission area, inside which the zone information is transmitted, correspond with each other. A mobile phone MS 130 inside the passenger cell 110 receives the zone information transmitted by the zone information transmitter 120. It determines—as will be explained in more detail later—an operational parameter setting from said received zone information and adjusts it. For example, the call tone can be adjusted to the highest possible loudness and the vibration alarm can be deactivated for the location zone “car”.

In the example illustrated in FIG. 1 the zone information transmitter 120 is connected to an outside antenna 140 of the vehicle 100. The zone information transmitter 120 comprises a Bluetooth™ transceiver for the connection to a mobile terminal and a transceiver for the connection to a mobile radio system, i.e. to a base station RBS 150 of the mobile radio system. The connection with the mobile radio system is realized via the outside antenna 140 of the vehicle 100. The mobile phone MS 130 comprises a mobile radio transceiver for the connection with the mobile radio system, and a Bluetooth™ transmission means for the connection with the zone information transmitter 120. Outside the passenger cell 110 the mobile phone 130 uses its mobile radio transceiver and an integrated antenna for the connection with the base station 150 of the mobile radio system. Inside the vehicle, i.e. in the passenger cell 110, screening effects, which may be caused by the metallic body of the vehicle, render said connection difficult. By means of the received zone information “car” the mobile phone MS 130 adjusts its operational parameters such that the mobile radio transceiver is switched off and the connection with the mobile radio system is realized with the Bluetooth™ transceiver. Inside the vehicle the mobile phone, therefore, uses its Bluetooth™ transmission means so as to set up a connection with the base station 150 by means of the zone information transmitter 120 and the outside antenna 140, instead of setting up a connection with the base station 150 via its mobile radio transceiver and the integrated antenna.

Although it is advantageously in a car to switch the mobile radio transceiver off, it is not necessary to do so. The invention allows as well for the simultaneous operation of both transceivers. In a further embodiment can the user choose the transceiver for communication, e.g. via a corresponding menu, button etc.

Additional examples for operational parameter settings of a mobile terminal provided with a mobile radio transceiver and a Bluetooth™ transmission means, which can be realized on the basis of the received zone information “car”, relate to the transfer of terminal functions to external devices. By means of the Bluetooth™ transmission technique, for example, corresponding microphones installed in the car, car loudspeakers of the stereo or a keyboard or a display of the onboard car computer may be connected wirelessly to the mobile phone. The operational parameter setting allocated to the zone information “car” then causes the mobile phone to use said present external devices instead of the integrated devices.

FIG. 2 shows the use of the invention, wherein the limited transmission area, inside which the zone information is wirelessly transmitted, and the location zone, to which the allocated operational parameter setting of a mobile terminal applies, do not correspond with each other. Shown are an access 200, e.g. a gangway, to a location area 240, e.g. an airplane cabin. The access 200 comprises a zone information transmitter BS 220 sending out a zone information, e.g. the zone information “airplane”, inside a limited transmission area 210 being located within the access 200. Outside the transmission area or the location zone a mobile phone MS 250 is provided with an operational parameter setting. As soon as a mobile phone MS 230 is located in the transmission area 210, it receives a zone information. It determines by means of the zone information operational parameters and adjusts them. On the basis of a zone information “airplane” an operational parameter “Off” can, for instance, be determined. The setting of said operational parameters effects the deactivation of the mobile phone. A mobile phone MS 260 in the location zone 240 is, therefore, switched off.

The sending out of the zone information through the zone information transmitter 220 can take place continuously or in certain time intervals, or, for instance, by means of a light barrier being installed in the access. A difference can be made between users entering the location zone and users leaving the location zone, so as to send different zone information for said users. This allows, for example, when the location zone 240 is left, a re-adjustment of the operational parameter setting of the mobile phone to its previous setting. In the indicated example, the mobile phone MS 260 is ready to receive a zone information when leaving the location zone 240, if, even though the mobile phone is switched off by setting the operational parameter “Off”, the transmission means for receiving the zone information is in a stand-by mode, or if the mobile phone is switched on again by the user.

In the following, transmission mechanisms of the zone information are explained without a figure. The transmission of the zone information is preferably realized by a broadcast transmission on a broadcast channel through the zone information transmitter BS, i.e. the transmission takes place continuously or in certain time intervals. A receiver in the mobile terminal monitors the broadcast channel continuously or in regular time intervals, and receives the zone information, if the terminal is located in the transmission area. In another embodiment of the present invention the zone information transmitter BS transmits the zone information as response to a corresponding zone information request. Said request can be sent to the zone information transmitter by either the mobile terminal or by another device, for example, a light barrier in the access zone. A zone information request sent by the mobile terminal can be transmitted by the terminal, for example, on a broadcast channel continuously or in regular time intervals.

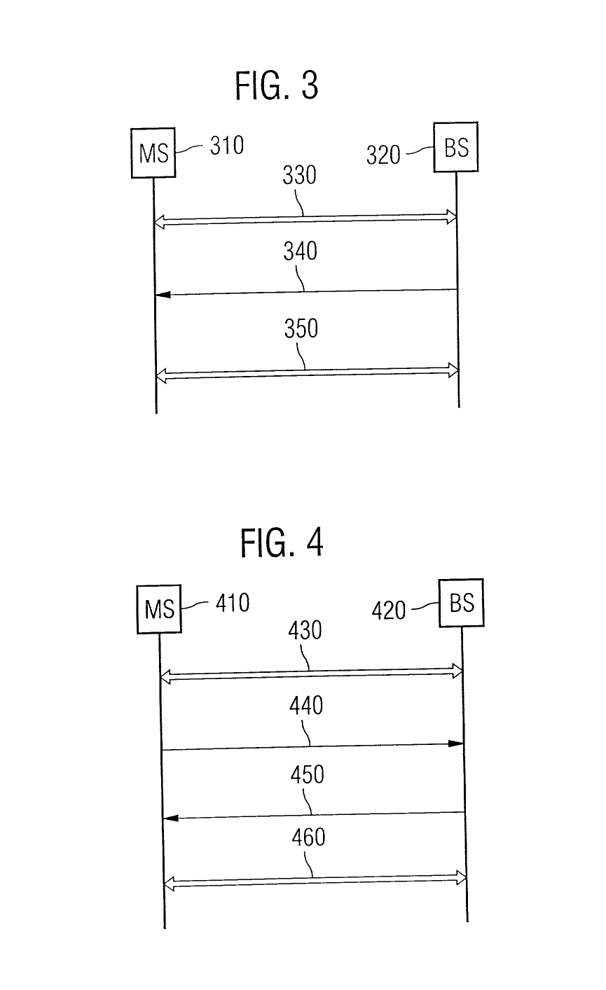

FIG. 3 shows an exchange of information between a zone information transmitter BS 320 and a mobile phone MS 310 for the application already described under FIG. 1. Both devices comprise a Bluetooth™ transmission means and additionally a mobile radio transceiver, e.g. a transceiver for GSM or GPRS. If the mobile phone MS 310 is located in the transmission area of the zone information transmitter BS 320, a communication connection between both devices is set up. The messages exchanged for the purpose of setting up a basic Bluetooth™ communication connection are illustrated in a message bundle 330. Said message bundle 330 effects the set-up of an ad hoc connection, i.e. generally the establishment of a pico-network consisting of two communicating partners, or the registration in a scafternet consisting of several pico-nets. Among others, it can comprise the set-up of the connection by way of a wake-up carrier, a frequency synchronization, a definition of master and slave functions as well as an authentication. Additional information on Bluetooth™ and a corresponding connection set-up may be inferred from the article ‘Bluetooth—The universal radio interface for ad hoc, wireless connectivity’ by Jaap Haartsen, Ericsson Review No. 3, 1998, pages 110-117. By means of the message bundle 330, messages from safety functions of higher protocol layers may additionally be exchanged, for example, for authentication.

Once the basic connection between the mobile phone MS 310 and the zone information transmitter BS 320 is established, the zone information transmitter BS 320 sends out a zone information 340. The zone information may, for example, be an identifier of the zone information transmitter BS 320. Alternatively, the zone information—as will be explained in more detail later—can comprise one or more zone information portions, e.g. a general zone information, a user-dependent group zone information, a user-independent group zone information, an individual user-dependent zone information, or an individual user-independent zone information. The zone information may also be a Bluetooth™-address or an IP-address.

The mobile phone MS 310 determines by means of the received zone information operational parameters and sets them. One operational parameter setting, which is set in the application according to FIG. 1, relates to the deactivation of the integrated mobile radio transceiver and the activation of the integrated Bluetooth™ transmission means for the communication with the mobile radio network. The communication then does not directly take place with the base station, but indirectly via the zone information transmitter BS 320. The exchange of messages required therefor, which may relate to either signaling information or to user information, is illustrated by the message bundle 350 in FIG. 3 in a simplified manner. In a possible embodiment the information exchanged in an indirect communication by means of the zone information transmitter completely correspond to those, that would be exchanged in a direct communication with the mobile radio network.

In another embodiment of the invention the zone information is already exchanged during the set-up of the basic Bluetooth™ connection. A scatternet identifier can, for instance, be transmitted as zone information. The message with the zone information 340 is in this case contained in message bundle 330.

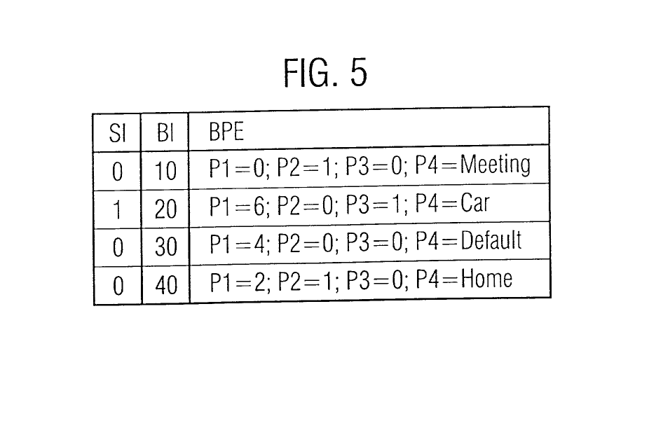

Another example for the exchange of information between a zone information transmitter BS 420 and a mobile phone MS 410 for the application already described under FIG. 1 is illustrated in FIG. 4. In contrast to the exchange of information already described under FIG. 3, the mobile phone MS 410 sends—once a basic Bluetooth™ connection 430 is established—a zone information request 440 to the zone information transmitter BS 420. The zone information request 440 preferably contains an identifier of the mobile phone MS 410. It may contain one or more portions identifying the mobile phone or its user, such as a general request part, e.g. ‘mobile phone’, a user-dependent group request part, e.g. ‘official phone’, a user-independent group request part, e.g. ‘mobile phone_of_manufacturer_X’, an individual user-dependent request part, e.g. the phone number of the user, or an individual user-independent request part, e.g. ‘phone type_Y’. The zone information request 440 may also be a Bluetooth™-address or an IP-address of the mobile phone, which is interpreted in the zone information transmitter BS 420 for determining a zone information.

The zone information transmitter BS 420 determines by means of the received zone information request 440 a zone information 450 and transmits it to the mobile phone MS 410. The determination of the zone information can be realized by means of a method similar to that of the determination of an operational parameter setting performed in the mobile phone by means of a received zone information. For this purpose, possible zone information requests and allocated zone information are preferably stored in the zone information transmitter BS 420. By comparing the stored zone information requests with the received zone information request 440 the zone information transmitter BS 420 determines the allocated zone information. Alternatively, an interpretation provision is stored in the zone information transmitter BS 420, by means of which the determination of the zone information is realized by interpreting the received zone information request 440. In another embodiment of the invention the determination of the zone information is effected by a combination of comparisons and interpretations.

The determination and setting of the operational parameters performed upon reception of the zone information 450, as well as the communication with the mobile radio network are realized as described under FIG. 3. The exchange of messages required for the communication with the mobile radio network is illustrated in FIG. 4 in a simplified manner by means of the message bundle 450.

In another embodiment of the invention the zone information request and the zone information are already exchanged during the set-up of the basic Bluetooth™ connection, for example, during the authentication. The messages comprising the zone information request 440 and zone information 450 are in this case contained in message bundle 430.

FIG. 5 shows an allocation of zone information and operational parameter settings being stored in the mobile terminal. An operational parameter setting BPE and a status information Si are respectively allocated to the zone information BI. The zone information BI is a numerical value (10, 20, 30, 40). The status information accepts the values ‘0’ or ‘1’. The status information ‘1’, also called flag, designates a presently set operational parameter setting of the terminal, while the status information ‘0’ indicates that the corresponding operational parameter setting is presently not activated. Four different operational parameters (P1, P2, P3, P4) can be set. P1 accepts integer values between 0 and 6 and adjusts, for example, the call loudness of a mobile phone. P2 and P3 can accept the values 0 and 1. P2=1 activates, for example, the vibration alarm of a mobile phone. P3=1 activates, for example, a Bluetooth™ transmission means for the communication with a mobile radio network and deactivates a GSM transceiver of the mobile phone at the same time. P4 is a character string, which contains, for example, a text displayed on a display of the mobile phone. The active setting illustrated in FIG. 5 is allocated to the zone information ‘20’. The corresponding operational parameter setting provides for call loudness ‘6’, deactivated vibration alarm, activated Bluetooth™ transmission means and the indication ‘car’ on the display. As soon as the mobile phone receives a zone information, it determines by comparing the received zone information with stored zone information, whether a correspondence exists. If there is a correspondence indicating another one than the present operational parameter setting, the operations parameters allocated to the corresponding zone information are set by re-setting the flag. If, for example, the zone information ‘40’ is received, the mobile phone compares said value with the values stored in column BI. A correspondence is found in the fourth line. Thereupon a new status information is determined, i.e. a ‘0’ is entered into line 2 as status information so as to deactivate the previous operational parameter setting, and a ‘1’ is entered in line 4 as status information so as to set an operational parameter setting providing for the call loudness ‘2’, activated vibration alarm, activated GSM transceiver and the display ‘Home’ on the display.

In another embodiment, described without figure, the allocation table contains as zone information BI numerical values, and as respectively allocated operational parameter settings BPE one or more AT commands in the form of one or more character strings. The table does not comprise a status information SI. The setting of an operational parameter setting is realized by reading out the AT commands, which are allocated to a zone information BI, and by the additional processing of said AT commands by the computer unit of the terminal. Details in view of AT command for setting operational parameters in a mobile phone are, for example, indicated in the ETSI Standard TS 100 916, Version 7.5.0.

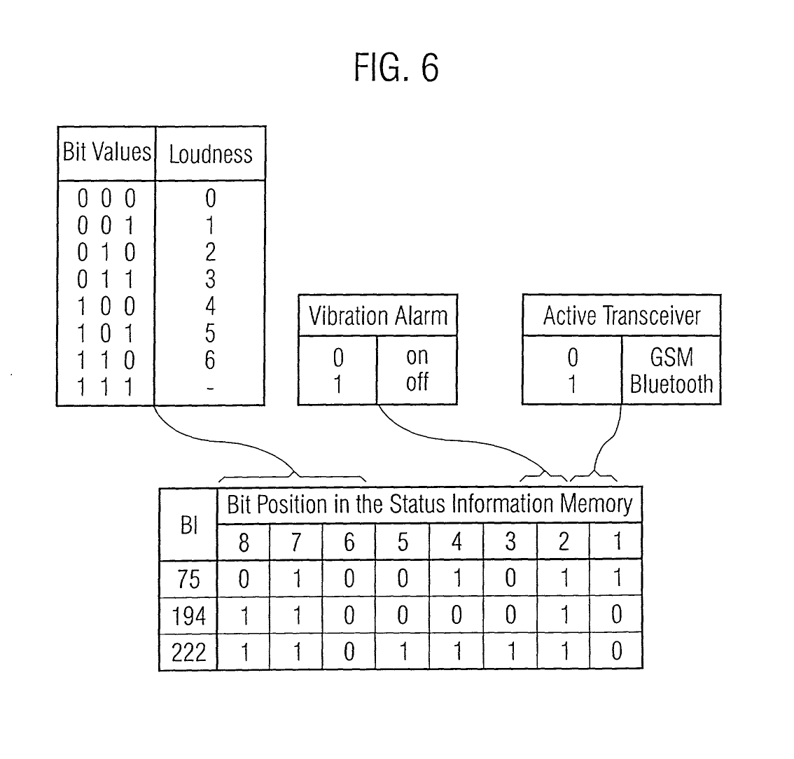

FIG. 6 shows an example of an interpretation provision for a received zone information. The zone information BI is a decimal value capable of accepting values from 0 to 255, i.e. the zone information can be represented by a byte. In a mobile phone as terminal, the binary representation of the zone information is interpreted by means of the bit values. The received zone information BI is stored in a status information memory of the terminal in a binary representation. In the indicated example the operational parameter setting is realized by the interpretation of the sixth, seventh and eighth bit position for setting the call loudness, by the interpretation of the second bit position for the vibration alarm and by the interpretation of the first position for the active transceiver. The three bits for the call loudness enable the settings ‘0’ to ‘6’. For instance, the call loudness ‘0’ corresponds to the bit values 000, and the call loudness ‘6’ corresponds to the bit values 110. The bit value 111 is not occupied. The vibration alarm is activated by the bit value 1 of the second bit position of the status information memory and is deactivated by the bit value 0. The bit value 1 on the first bit position defines a Bluetooth™ transceiver of the terminal as active transceiver, while the bit value 0 sets a GSM transceiver to be the active transceiver. The received zone information 75, which is stored as binary value 01001011 in the status information memory, results in the setting of the call loudness ‘2’, activated vibration alarm and activated Bluetooth™ transceiver.

The third, fourth and fifth bit positions are not occupied in the example indicated, i.e. the are not evaluated for the operational parameter setting. Therefore, the received zone information BI=75, binary 11000010, and BI=222, binary 11011110, for example, result in the same operational parameter setting.

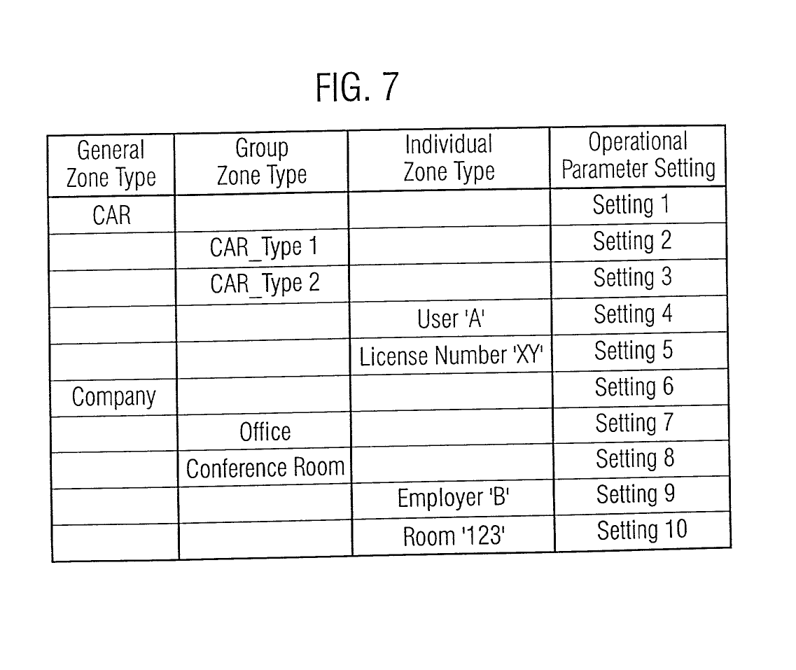

A zone information transmitted by a zone information transmitter may contain one or more zone types. FIG. 7 exemplarily shows different zone types of which a zone information may consist, as well as the allocation thereof to operational parameter settings in the terminal. Shown are a general zone type (‘car’, ‘company’), a group zone type (‘car_type1, ‘car_type 2’) and an individual zone type (“user'A′”, “license number'XY′”, “employee'B′”, “room'123′”). The general zone type being of a higher order effects an operational parameter setting in the terminal, which is equal for all location zones of this type. It is evaluated by a plurality of terminals, The zone information ‘car’ in terminals according to the invention, for instance, results in ‘setting 1’ in all cars, i.e. independently of the type of car or the user of the terminal. If a definite evaluation of the zone information by means of the stored comparative data is impossible, the transmitted zone information can additionally be interpreted by means of an interpretation provision.

The group zone type allows a differentiated setting of operational parameters for the location zone. There are user-dependent and user-independent group zone types. Thus, equal operational parameter settings for specific user groups or specific groups of locations zones are effected, which enables, for example, the members of a user group to access mutual resources of the group.

The individual zone type effects a specific operational parameter setting for a specific location zone or for a specific user. This allows the setting of personal operational parameters in the terminal individually specified by the user. A personalized program environment can, for instance, be set in a laptop.

A multipart zone information preferably has a format of an DNS-address, e.g. “company.office.room123”. A zone information transmitter can send the different parts of the zone information together in one message or distributed over several messages.

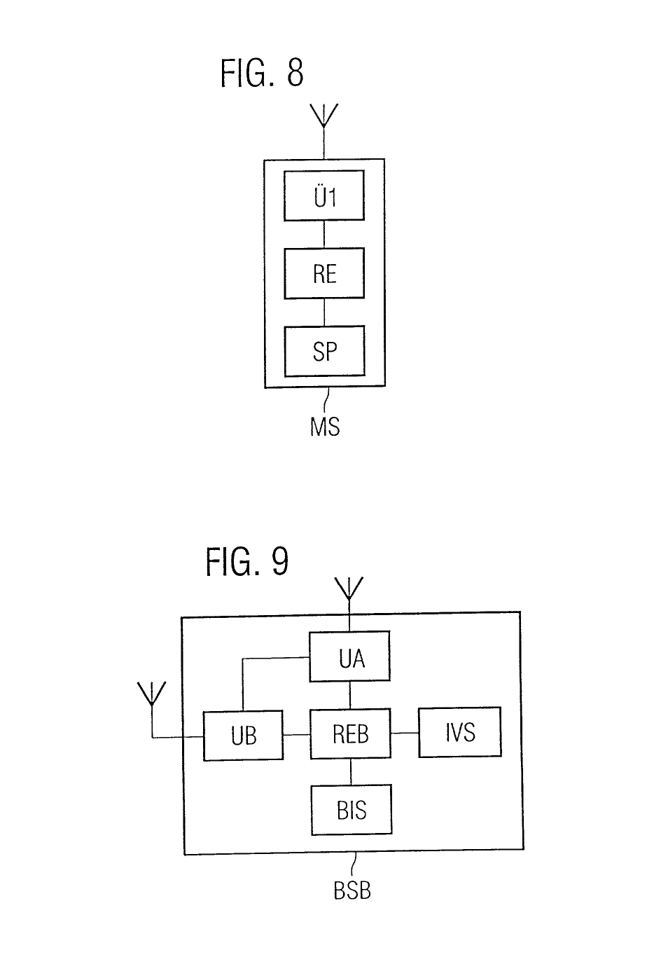

FIG. 8 shows a simplified representation of components of a mobile terminal MS. Shown are a first transmission means Ü1 wirelessly receiving a zone information. The transmission means Ü1 is connected to a computer unit RE, which determines operational parameters of the terminal MS by means of the received zone information. The computer unit RE is connected to a status memory SP. The computer unit RE adjusts by means of the status memory SP the determined operational parameters as parameters of the terminal.

In an embodiment the mobile terminal MS moreover comprises a zone information memory, in which the zone information and the operational parameters are allocated to each other. In an alternative embodiment a mutual memory comprises sections for zone information memory data or status memory data.

In another embodiment the mobile terminal MS moreover comprises an interpretation provision memory, in which an interpretation provision for a zone information is stored. In an alternative embodiment said interpretation provision memory is integrated in the status memory or in the zone information memory. In another embodiment a SIM card of the terminal comprises components, such as the computer unit RE, the zone information memory or the interpretation provision memory.

FIG. 9 shows in a simplified illustration components of a zone information transmitter BSB. The zone information transmitter BSB comprises a first transmission means UA, a second transmission means UB, a zone information memory BIS and an interpretation provision memory IVS. Furthermore, the zone information transmitter comprises a computer unit REB, which is connected to all other components.

The first transmission means receives a zone information request and sends out an allocated zone information. The zone information is determined by the computer unit from the zone information request by means of zone information data stored in the zone information memory BIS and by means of an interpretation provision contained in the interpretation provision memory IVS. The second transmission means UB serves a communication set-up between a mobile radio device and a mobile radio network. Both transmission means UA, UB are coupled with each other. In the uplink case of a communication with the mobile radio network the first transmission means UA receives user data and signaling information from the terminal and forwards them to the second transmission means UB, which forwards them to the communication system. The downlink case takes place vice versa. The computer unit REB respectively controls the operation of the transmission means UA, UB. In an alternative embodiment the components of the zone information transmitter BSB are combined. Memories IVS, BIS may, for instance, represent memory sections of a mutual memory. Memories IVS, BIS may be integrated in the computer unit REB.

A further embodiment of the invention introduces a localisation information. This embodiment is explained in the following with reference to an exemplary application scenario of a GSM-Bluetooth mobile terminal.

The embodiment allows to determine not only the existence of a location zone, e.g. a Bluetooth pico cell, but also the distance to the corresponding control instance, e.g. the car or the zone information transmitter. Thereby the setting of operational parameters is limited to a certain distance from the control instance. This is especially useful for Bluetooth phase 2 wherein a larger radio cell up to 100 m is under investigation.

Basically one or all communication partners, i.e. the mobile phone and/or the zone information transmitter, become localisation aware, i.e. the distance of two communicating partners is determined.

In one embodiment this is enabled by external means, e.g., an additional device like a GPS device connected to the mobile terminal or to the zone information transmitter, which generates localisation information, or be internal means of the mobile terminal, e.g., by determination of signal strength of the received zone information signal and thereby approximating the distance. The localisation-aware mobile terminal neglects the change of its settings if the distance between the communicating parties is larger then a predefined reference value.

Alternatively, the distance parameter indicates the field strength of the received zone information signal. In this case, the terminal neglects the setting changes, if the parameter value is lower than a predefined reference value.

If the distance parameter value is available at a communicating partner, the partner decides in a further embodiment in the case of a mobile terminal whether the distance is short enough to accept the zone information and a corresponding change of its operational parameter settings, or in the case of a zone information transmitter, whether the zone information request is to be responded.

If only one of the communicating parties, i.e. only the mobile terminal or only the zone information transmitter, is aware of the distance between the communicating parties, e.g., a Bluetooth master device within the car, then this device informs in another embodiment of the invention, e.g. on request, an other party about its position.

As a further embodiment, the reference value is negotiated between the communicating parties, i.e. between the mobile terminal and the zone information transmitter. Thereby a differentiation between different users is possible. E.g., a car owner can have the allowance to use a larger distance than other users. The decision whether a larger distance is accepted or not optionally depends also on other criteria like secure credentials identifying the car owner or by a list stored in the device in the car.

The distance parameter value allows for a more refined usage location zones. Their effective coverage can be restricted very close to a target environment, which is useful already for Bluetooth phase 1, but even more for future phases, which shall support larger cell sizes.

Another embodiment of the invention relates to a computer program. The computer program, which can be loaded in an internal memory of a digital computer unit, especially a mobile phone, comprises software code parts being suited to perform the method according to the invention when the computer program is executed on the computer unit.

Said computer program can especially also be stored on a computer-readable medium, such as a floppy disc, CD-ROM or an optical disk.

1. Method for setting operational parameters of a mobile terminal (MS) having operational parameter settings (BPE), which depend on a location zone (110; 210) of the terminal (MS), wherein a zone information (BI) being wirelessly transmitted in a limited transmission area (110; 240) is allocated to the location zone (110, 210), and wherein the mobile terminal (MS) comprises a first transmission means (Ü1) and a second transmission means, wherein the second transmission means is provided for a communication with a mobile radio system, said method comprising the steps
receiving the zone information (BI) by the mobile terminal (MS),
determining operational parameters in the terminal (MS) by means of the received zone information (BI),
setting the determined operational parameters as operational parameters of the terminal (MS), such that the communication with the mobile radio system is provided by means of the first transmission means (Ü1).

2. Method according to claim 1, wherein the terminal (MS) transmits a zone information request (450).

3. Method according to claim 1 or 2, wherein zone information (BI) and operational parameters are allocated to each other and stored in the terminal (MS), the determination of the operational parameters is realized by comparing the received zone information with stored zone information for determining a correspondence, and wherein the operational parameters allocated to the corresponding zone information are determined as operational parameters.

4. Method according to claim 1, 2 or 3, wherein an interpretation provision is stored in the terminal (MS), and wherein the determination of the operational parameters is realized by interpreting the received zone information by means of the interpretation provision.

5. Method according to one of claims 1 to 4, wherein the setting of the determined operational parameters is realized by storing a status information in a status information memory of the terminal (MS).

6. Method according to one of the claims 1 to 5, wherein the first transmission means is a short range transceiver.

7. Method according to one of the preceding claims, wherein the second transmission means is deactivated by setting the operational parameters.

8. Method according to one of the preceding claims, wherein the received zone information (BI) comprises several zone types.

9. Method according to one of the preceding claims, wherein the zone information (BI) is received by the first transmission means (Ü1).

10. Method according to one of the preceding claims, wherein the mobile terminal (MS) determines a distance parameter value, and wherein the steps of determining operational parameters in the terminal (MS) and setting the determined operational parameters are performed if the distance parameter value indicates that the mobile terminal (MS) is located within the location zone (110;210).

11. Method according to claim 10, wherein the distance parameter value is determined by means of a location information (GPS).

12. Method according to claim 10 or 11, wherein the distance parameter value is determined by means of a signal received from a sender signaling the zone information (BI).

13. Method according to any of the claims 10 to 12, wherein the indication, whether the mobile terminal (MS) is located within the location zone (110;21 0) is determined by comparing the distance parameter value with a reference value.

14. Method according to claim 13, wherein the reference value is negotiated between the mobile terminal (MS) and a sender signaling the zone information (BI).

15. Method according to one of the preceding claims, wherein the switchover to the first transmission means is performed on a user request.

16. Mobile terminal (MS) having operational parameter settings (BPE), which can be set by means of a wirelessly transmitted zone information (BI), comprising
a status memory (SP) indicating the operational parameters presently valid for the terminal (MS),
a first transmission means (Ü1) for receiving the zone information,
a computer unit (RE) determining operational parameters by means of the received zone information (BI) and setting them as operational parameters for the terminal by means of the status memory (SP).
a second transmission means for the communication with a mobile radio network,
wherein the communication with the mobile radio system is adapted to be provided by means of the first transmission means (Ü1).

17. Mobile terminal (MS) according to claim 16, wherein the second transmission means is adapted to be deactivated by setting the operational parameters.

18. Mobile terminal (MS) according to claim 16 or 17, wherein the first transmission means (Ü1) transmits a zone information request.

19. Mobile terminal (MS) according to claim 16, 17 or 18, comprising a zone information memory, in which zone information (BI) and operational parameters are allocated to each other and stored, and wherein the computer unit (RE) detects a correspondence between the received zone information and a stored zone information by means of comparison and determines the operational parameters allocated to the corresponding zone information as operational parameters.

20. Mobile terminal (MS) according to one of the claims 16 to 19, wherein the computer unit (RE) determines operational parameters from the received zone information (BI) by means of an interpretation provision.

21. Mobile terminal according to one of the claims 16 to 20, wherein the first transmission means is a short range transceiver.

22. Mobile terminal (MS) according to one of the claims 16 to 21, adapted to determine a distance parameter value indicative for a distance of the mobile terminal to the location zone.

23. Mobile terminal (MS) according to one of the claims 16 to 22, adapted to determine an indication, whether the mobile terminal is located within a location zone (110;210), by comparing the distance parameter value with a reference value.

24. Mobile terminal according to one of the claims 16 to 23, adapted to negotiate the reference value with a zone information transmitter.

25. Mobile terminal according to one of the claims 16 to 24, adapted to perform the switchover to the first transmission means on request of a user.

26. Zone information transmitter (BSB) for signaling a zone information (BI) for setting operational parameters of a mobile terminal (MS), comprising
a first transmission means (UA) receiving a zone information request (BI) and wirelessly sending out an allocated zone information (BI) in a limited transmission area (110, 210),
a zone information memory (BIS) storing zone information data, and
a computer unit (REB) determining by means of the stored zone information data the zone information (BI), which is allocated to the zone information request.

27. Zone information transmitter (BSB) according to claim 26, wherein the zone information transmitter (BSB) is mobile.

28. Zone information transmitter (BSB) according to claim 26 or 27, wherein zone information requests and zone information (BI) are allocated to each other and stored in the zone information memory (BIS), and wherein the computer unit (REB) detects a correspondence between the received zone information request and a stored zone information request by means of comparison and determines the zone information allocated to the corresponding zone information request as zone information to be sent.

29. Zone information transmitter (BSB) according to one of claims 26 to 30, wherein the computer unit (REB) determines the zone information (BI) by means of an interpretation provision.

30. Zone information transmitter (BSB) according to one of claims 26 to 29, adapted to negotiate a reference value with the mobile terminal (MS), wherein said reference value is provided for a comparison with a distance parameter value to indicate whether the mobile terminal (MS) is located within the location zone (110;210).

31. Zone information transmitter (BSB) according to one of claims 26 to 30, comprising a second transmission means (UB) for the communication with a mobile radio network.

32. Method for setting operational parameters of a mobile terminal (MS) having operational parameter settings (BPE), which depend on a location zone (110; 210) of the terminal (MS), wherein a zone information (BI) being wirelessly transmitted in a limited transmission area (110; 240) is allocated to the location zone (110, 210), comprising the steps
receiving the zone information (BI) by the terminal (MS),
determining a distance parameter,
if the distance parameter indicates that the mobile terminal (MS) is located within the location zone (110;210), performing the steps of
determining operational parameters in the terminal (MS) by means of the received zone information (BI), and
setting the determined operational parameters as operational parameters of the terminal (MS).

33. Computer program capable of being loaded into an internal memory of a digital computer unit and comprising software code parts being suited to perform the steps according to one of claims 1 to 15 and 32, if the computer program is executed on the computer unit.

34. Computer program according to claim 33, wherein the computer program is stored on a computer-readable medium.
